(19) United States
(12) Patent Application Publication
(10) Pub. No.: US 2025/0173639 A1
(43) Pub. Date: May 29, 2025

(54) FLEET MANAGEMENT FOR AUTONOMOUS VEHICLES

(71) Applicant: Waymo LLC, Mountain View, CA (US)

(72) Inventors: Craig Robinson, Santa Clara, CA (US); Vishruth Srinath, Santa Clara, CA (US); Jacob Patrick McKim, Ann Arbor, MI (US); Nikita Korolko, Chicago, IL (US); Rohan Taneja, San Francisco, CA (US); Shantanu Sathe, Seattle, WA (US); Peter Caffeine, San Francisco, CA (US); Helene Grossman, Palo Alto, CA (US); Ruben Lobel, Burlingame, CA (US); Guillaume Jean Nicolas Ryder, Mountain View, CA (US)

(21) Appl. No.: 18/950,372

(22) Filed: Nov. 18, 2024

Related U.S. Application Data
(60) Provisional application No. 63/603,353, filed on Nov. 28, 2023.

(51) Int. Cl. G06Q 10/0631; G05D 1/69; G05D 105/22; G05D 109/10; G06Q 10/0639

(52) U.S. Cl. CPC G06Q 10/06311; G05D 1/69; G06Q 10/06315; G06Q 10/0639; G05D 2105/22; G05D 2109/10

(57) ABSTRACT

Aspects of the disclosure provide for managing a fleet of autonomous vehicles of a transportation service. For instance, a plurality of inputs including a current demand for services, predictions about future demand for services, and current status of the fleet may be identified. The current status may include information identifying one of a plurality of predefined states for each autonomous vehicle of the fleet. A schedule may be determined based on the plurality of inputs. The schedule may define a number of autonomous vehicles that should be in each of the plurality of expected future states. The schedule may be used to determine an assignment for each of the autonomous vehicles to one of the plurality of predefined states.

### CROSS REFERENCE TO RELATED APPLICATIONS

The present application claims the benefit of the filing date of U.S. Provisional Application No. 63/603,353, filed Nov. 28, 2023, the entire disclosure of which is incorporated by reference herein.

### BACKGROUND

Autonomous vehicles for instance, vehicles that may not require a human driver, can be used to aid in the transport of passengers or items from one location to another. Such vehicles may operate in a fully autonomous mode where passengers may provide some initial input, such as a pickup or destination location, and the autonomous vehicle maneuvers itself to that location. Autonomous vehicles are equipped with various types of sensors in order to detect objects in the surroundings. For example, autonomous vehicles may include sonar, radar, camera, lidar, and other devices that scan, generate and/or record data about the autonomous vehicle's surroundings. The sensor data may be combined with pre-stored map information in order to enable the autonomous vehicle to plan trajectories in order to maneuver itself through the surroundings along a route.

### BRIEF SUMMARY

One aspect of the disclosure provides a method for managing a fleet of autonomous vehicles of a transportation service. The method includes identifying, by one or more processors, a plurality of inputs including a current demand for services, predictions about future demand for services, and a current status of the fleet of autonomous vehicles including information identifying one of a plurality of predefined states for each autonomous vehicle of the fleet of autonomous vehicles; determining, by the one or more processors, a schedule based on the plurality of inputs, wherein the schedule defines a number of autonomous vehicles of the fleet of autonomous vehicles that are predicted to be in each of a plurality of expected future states; using, by the one or more processors, the schedule to determine an assignment assigning each of the autonomous vehicles of the fleet of autonomous vehicles to one of the plurality of predefined states; and sending, by the one or more processors, to one of the autonomous vehicles of the fleet of autonomous vehicles an instruction to update the current status of the one of the autonomous vehicles based on the assignments, the instruction configured to cause the one of the autonomous vehicles of the fleet of autonomous vehicles to automatically change a behavior of the one of the autonomous vehicles of the fleet of autonomous vehicles.

In one example, the method also includes optimizing the schedule for a variable of interest. In this example, the variable of interest includes a number of trips. In another example, the plurality of inputs further includes a number of depot areas for the transportation service, locations for the depot areas, and statuses of the depot areas. In another example, the current demand for services includes a number of users who currently have an application for the transportation service open and have identified a destination. In another example, the method also includes, determining the future demand for services based on historical demand for transportation service. In another example, determining the schedule includes determining expected future states for a plurality of timesteps. In this example, the method also includes evaluating performance of the transportation system by comparing the expected future states for the plurality of timesteps to actual states of the autonomous vehicles of the fleet of autonomous vehicles at corresponding times. In addition, or alternatively, the schedule further defines a number of autonomous vehicles of the fleet of autonomous vehicles that should be in each of the plurality of expected future states for each of the plurality of timesteps. In another example, determining the schedule includes determining when an autonomous vehicle of the fleet of autonomous vehicles will require maintenance. In another example, determining the schedule includes determining an amount of time that each autonomous vehicle of the fleet of autonomous vehicles will remain in a current state for that autonomous vehicle of the fleet of autonomous vehicles. In another example, using the schedule to determine the assignment includes using a plurality of downstream models arranged in a hierarchy. In this example, the method also includes using output of the plurality of downstream models to identify an updated plurality of inputs in order to perform a second iteration of determining a schedule.

Another aspect of the disclosure provides a system for managing a fleet of autonomous vehicles of a transportation service. The system comprising one or more processors configured to: identify a plurality of inputs including a current demand for services, predictions about future demand for services, and a current status of the fleet of autonomous vehicles including information identifying one of a plurality of predefined states for each autonomous vehicle of the fleet of autonomous vehicles; determine a schedule based on the plurality of inputs, based on the current state, wherein the schedule defines a number of autonomous vehicles of the fleet of autonomous vehicles that are expected to be in each of a plurality of expected future states; use the schedule to determine an assignment assigning each of the autonomous vehicles of the fleet of autonomous vehicles to one of the plurality of predefined states; and send to one of the autonomous vehicles of the fleet of autonomous vehicles an instruction to update the current status of the one of the autonomous vehicles of the fleet of autonomous vehicles based on the assignments, the instruction configured to cause the one of the autonomous vehicles of the fleet of autonomous vehicles to automatically change a behavior of the one of the autonomous vehicles of the fleet of autonomous vehicles.

In one example, the one or more processors are further configured to optimize the schedule for a variable of interest. In another example, the one or more processors are further configured to determine the schedule by determining expected future states for a plurality of timesteps. In this example, the one or more processors are further configured to evaluate performance of the transportation system by comparing the expected future states for the plurality of timesteps to actual states of the autonomous vehicles of the fleet of autonomous vehicles at corresponding times. In addition or alternatively, the schedule further defines a number of autonomous vehicles that should be in each of the plurality of expected future states for each of the plurality of timesteps. In another example, determining the schedule includes determining an amount of time that each autonomous vehicle of the fleet of autonomous vehicles will remain in a current state of that autonomous vehicle of the fleet of autonomous vehicles. In another example, the system also includes the fleet of autonomous vehicles.

### BRIEF DESCRIPTION OF THE DRAWINGS

FIG. 1 is a functional diagram of an example vehicle in accordance with an exemplary embodiment.

FIG. 2 is an example of map information in accordance with aspects of the disclosure.

FIG. 3A-3B are example external views of a vehicle in accordance with aspects of the disclosure.

FIG. 4 is a pictorial diagram of an example system in accordance with aspects of the disclosure.

FIG. 5 is a functional diagram of the system of FIG. 4 in accordance with aspects of the disclosure.

FIG. 6 is an example representation of a fleet management process in accordance with aspects of the disclosure.

FIG. 7 is an example of map information and autonomous vehicles in accordance with aspects of the disclosure.

FIG. 8 is an example of map information, autonomous vehicles, and state messages in accordance with aspects of the disclosure.

FIG. 9 is an example of map information, autonomous vehicles, and instructions in accordance with aspects of the disclosure.

FIG. 10 is a flow diagram in accordance with aspects of the disclosure.

### DETAILED DESCRIPTION

### Overview

The technology relates to managing a fleet of autonomous vehicles of a transportation service where such autonomous vehicles are used for transportation of passengers or goods or other purposes. For instance, if at a certain future time 3 or 4 hours from now, 15 of autonomous vehicles will be needed to meet expected demand, sending out 15 autonomous vehicles now may result in all or some of those autonomous vehicles having low battery levels and needing to be charged at that future time. As a result, the autonomous vehicles may not be able to meet that future demand. Moreover, all or some of those 15 autonomous vehicles, needing to be charged, may arrive back at a charging location (e.g., a depot area as discussed further below) at or around the same time. This, in turn, may create congestion at the charging location, overwhelming resources at the depot, delaying the re-launch of these autonomous vehicles back into service, and further hindering the ability of the transportation service to meet the expected demand.

To avoid such situations, a fleet management system may automatically determine what such vehicles should be doing at a given point in time without the need for human operators to manage the system, thereby significantly reducing inefficiencies. This may involve various tradeoffs between current and future demand for the autonomous vehicles, costs (e.g., time, miles, expenses, maintenance, etc.), etc. which may vary depending on the configurations of the autonomous vehicles themselves, the number of autonomous vehicles, the current states of the autonomous vehicles, as well as numerous other considerations.

The fleet management system may first identify a plurality of inputs. These inputs may include current demand for services, predictions about future demand for services, the location and number of depots, location, capability, and status of the depots, current number and skills, qualifications or capabilities of personnel available at the depots, future numbers of personnel available at the depots, as well as the current status of each vehicle of the fleet of autonomous vehicles. Current demand for services may include information such as the number and approximate location of users who currently have an application for the transportation service open and may have entered a location as well as the number of requests for transportation of passengers or goods or other services currently received. Future demand for services, including volume and location of demand, may be based on historical demand, known future events, and other information. In some instances, the plurality of inputs may also include factors more directly related to revenue. The personnel at the depots may be persons who provide or otherwise enable maintenance at the depots.

The status of each autonomous vehicle may include information such as location, current destination, current route, whether the vehicle is transporting passengers or goods, information about the status of the autonomous vehicles' various systems, and information identifying one of a plurality of predefined states. This information may be reported to the fleet management periodically by the autonomous vehicles in state messages. Examples of such predefined states may include, for example, “off”, “in service”, “return to depot” (or base), “maintenance”, “on and staged”, and “waiting for next trip”. Other predefined states may also be possible depending on the configuration of the transportation system, autonomous vehicles, and/or types of services being provided.

The fleet management system may use the plurality of inputs to determine a schedule including a current state of the fleet of autonomous vehicles as well as a plurality of expected future states. In other words, the fleet management system may determine the aggregate fleet composition at a plurality of timesteps. In some instances, this schedule may be optimized for a particular goal or variable of interest.

In order to do so, some aspects of the system, such as when a given autonomous vehicle is likely to next require maintenance may be modeled. Such modeling may involve looking at historical data for the autonomous vehicles and generating predictive models. Such models may even involve training machine learned models trained on historical battery discharge rates and any or all of the aforementioned features. Of course, this modeling will be specific to each transportation service, the types of services provided, and the types of autonomous vehicles of the fleet. The resulting models may then be used by the fleet management system to generate the plurality of predicted future states.

Determining the expected future states may also involve estimating how long an autonomous vehicle will spend in its current state. These estimates may then be used by the fleet management system to generate the plurality of predicted future states.

While, in some instances, the fleet management system may output instructions for a few specific vehicles, the fleet management system may more efficiently process the current state of the fleet of autonomous vehicles as well as the plurality of expected future states if the output is more generalized. For example, the fleet management system may use the current state of the fleet of autonomous vehicles as well as the plurality of expected future predefined states for each of the timesteps to output a schedule including number of vehicles at each timestep which will be in each of the aforementioned states.

The schedule, including, number of autonomous vehicles of the fleets in each of predefined states at each timestep, may then be input into various downstream models for assigning specific vehicles to specific ones of the plurality of predetermined states. In other words, the fleet management system may use these downstream models to identify which autonomous vehicles should be assigned to what states and as such which autonomous vehicles need to be reassigned to new states.

One or more downstream models may be used to choose the exact autonomous vehicle by reading real time telemetry data from the autonomous vehicles. The downstream models may be arranged in a hierarchical structure such that the output of one downstream model may be input with the schedule into additional downstream models in order to determine the aforementioned assignments. The hierarchy or order of these downstream models may depend upon the configuration and goals of the transportation system. Each downstream model may output a set of specific autonomous vehicles and corresponding assignments. These assignments may include a predefined status for each autonomous vehicle.

The outputs of all of the downstream models may then be used to send instructions to the autonomous vehicles of the fleet. These instructions may cause at least some of the autonomous vehicles to automatically change a behavior of those autonomous vehicles by updating the incumbent or queued task assigned to those autonomous vehicles.

The outputs of all of the downstream models may also be used by the fleet management system in a next iteration. Thus, the fleet management system may constantly operate on a feedback loop. In this regard, the fleet management system may use this information to determine the next plurality of inputs and thereafter the new current state of the fleet of autonomous vehicles as well as a plurality of expected future states. This may continue automatically in order to continuously update the schedule and outputs of the downstream models. At each step in the process, the results may be stored by the fleet management system.

The features described herein may provide for a more efficient and practical approach to managing a fleet of autonomous vehicles. As noted above, a fleet management system may automatically determine what such vehicles should be doing at a given point in time without the need for human operators to manage the system, thereby significantly reducing inefficiencies. The features described herein may also allow for more quickly and efficiently reacting to changes, both expected and unexpected, in supply and demand conditions for the autonomous vehicles. This, in turn, may reduce unproductive driving (e.g., “wasted miles”) thereby increasing efficiency, reducing overall costs, and potentially increasing revenue to the transportation system.

### Example Systems

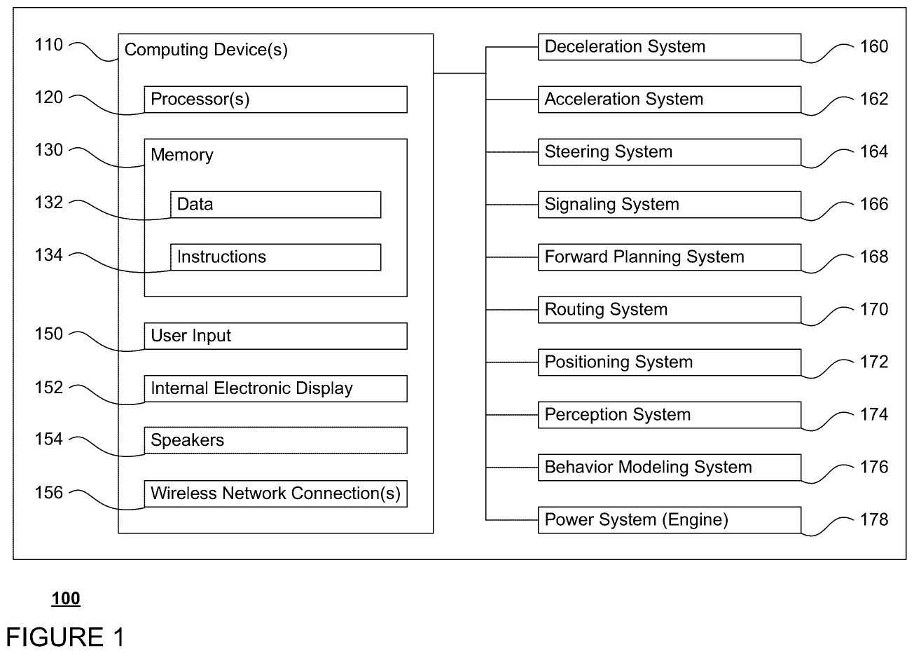

As shown in FIG. 1, an autonomous vehicle 100 in accordance with one aspect of the disclosure includes various components. Vehicles, such as those described herein, may be configured to operate in one or more different driving modes. For instance, in a manual driving mode, a driver may directly control acceleration, deceleration, and steering via inputs such as an accelerator pedal, a brake pedal, a steering wheel, etc. A vehicle may also operate in one or more autonomous driving modes including, for example, a semi or partially autonomous driving mode in which a person exercises some amount of direct or remote control over driving operations, or a fully autonomous driving mode in which the autonomous vehicle handles the driving operations without direct or remote control by a person. These vehicles may be known by different names including, for example, autonomously driven vehicles, self-driving vehicles, and so on.

The U.S. National Highway Traffic Safety Administration (NHTSA) and the Society of Automotive Engineers (SAE) have each identified different levels to indicate how much, or how little, a vehicle controls the driving, although different organizations may categorize the levels differently. Moreover, such classifications may change (e.g., be updated) overtime.

As described herein, in a semi or partially autonomous driving mode, even though the autonomous vehicle assists with one or more driving operations (e.g., steering, braking and/or accelerating to perform lane centering, adaptive cruise control or emergency braking), the human driver is expected to be situationally aware of the autonomous vehicle's surroundings and supervise the assisted driving operations. Here, even though the autonomous vehicle may perform all driving tasks in certain situations, the human driver is expected to be responsible for taking control as needed.

In contrast, in a fully autonomous driving mode, the control system of the autonomous vehicle performs all driving tasks and monitors the driving environment. This may be limited to certain situations such as operating in a particular service region or under certain time or environmental restrictions, or may encompass driving under all conditions without limitation. In a fully autonomous driving mode, a person is not expected to take over control of any driving operation.

Unless indicated otherwise, the architectures, components, systems and methods described herein can function in a semi or partially autonomous driving mode, or a fully-autonomous driving mode.

While certain aspects of the disclosure are particularly useful in connection with specific types of vehicles, the autonomous vehicle may be any type of vehicle including, but not limited to, cars, trucks (e.g. garbage trucks, tractor-trailers, pickup trucks, etc.), motorcycles, buses, recreational vehicles, street cleaning or sweeping vehicles, etc. The autonomous vehicle may have one or more computing devices, such as computing device 110 containing one or more processors 120, memory 130 and other components typically present in general purpose computing devices.

The memory 130 stores information accessible by the one or more processors 120, including data 132 and instructions 134 that may be executed or otherwise used by the processor 120. The memory 130 may be of any type capable of storing information accessible by the processor, including a computing device or computer-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 134 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below.

The data 132 may be retrieved, stored or modified by processor 120 in accordance with the instructions 134. For instance, although the claimed subject matter is not limited by any particular data structure, the data may be stored in computing device registers, in a relational database as a table having a plurality of different fields and records, XML documents or flat files. The data may also be formatted in any computing device-readable format.

The one or more processors 120 may be any conventional processors, such as commercially available CPUs or GPUs. Alternatively, the one or more processors may include a dedicated device such as an ASIC or other hardware-based processor. Although FIG. 1 functionally illustrates the processor, memory, and other elements of computing device 110 as being within the same block, it will be understood by those of ordinary skill in the art that the processor, computing device, or memory may actually include multiple processors, computing devices, or memories that may or may not be stored within the same physical housing. For example, memory may be a hard drive or other storage media located in a housing different from that of computing device 110. Accordingly, references to a processor or computing device will be understood to include references to a collection of processors or computing devices or memories that may or may not operate in parallel.

Computing devices 110 may include all of the components normally used in connection with a computing device such as the processor and memory described above as well as a user input 150 (e.g., one or more of a button, mouse, keyboard, touch screen and/or microphone), various electronic displays (e.g., a monitor having a screen or any other electrical device that is operable to display information), and speakers 154 to provide information to a passenger of the autonomous vehicle 100 or others as needed. For example, electronic display 152 may be located within a cabin of autonomous vehicle 100 and may be used by computing devices 110 to provide information to passengers within the autonomous vehicle 100.

Computing devices 110 may also include one or more wireless network connections 156 to facilitate communication with other computing devices, such as the client computing devices and server computing devices described in detail below. The wireless network connections may include short range communication protocols such as Bluetooth, Bluetooth low energy (LE), cellular connections, as well as various configurations and protocols including the Internet, World Wide Web, intranets, virtual private networks, wide area networks, local networks, private networks using communication protocols proprietary to one or more companies, Ethernet, WiFi and HTTP, and various combinations of the foregoing.

Computing devices 110 may be part of an autonomous control system for the autonomous vehicle 100 and may be capable of communicating with various components of the autonomous vehicle in order to control the autonomous vehicle in an autonomous driving mode. For example, returning to FIG. 1, computing devices 110 may be in communication with various systems of autonomous vehicle 100, such as deceleration system 160, acceleration system 162, steering system 164, signaling system 166, planning system 168, routing system 170, positioning system 172, perception system 174, behavior modeling system 176, and power system 178 in order to control the movement, speed, etc. of autonomous vehicle 100 in accordance with the instructions 134 of memory 130 in the autonomous driving mode.

As an example, computing devices 110 may interact with deceleration system 160 and acceleration system 162 in order to control the speed of the autonomous vehicle. Similarly, steering system 164 may be used by computing devices 110 in order to control the direction of autonomous vehicle 100. For example, if autonomous vehicle 100 is configured for use on a road, such as a car or truck, steering system 164 may include components to control the angle of wheels to turn the autonomous vehicle. Computing devices 110 may also use the signaling system 166 in order to signal the autonomous vehicle's intent to other drivers or vehicles, for example, by lighting turn signals or brake lights when needed.

Routing system 170 may be used by computing devices 110 in order to generate a route to a destination using map information. Planning system 168 may be used by computing device 110 in order to generate short-term trajectories that allow the autonomous vehicle to follow routes generated by the routing system. In this regard, the planning system 168 and/or routing system 166 may store detailed map information, e.g., pre-stored, highly detailed maps identifying a road network including the shape and elevation of roadways, lane lines, intersections, crosswalks, speed limits, traffic signals, buildings, signs, real time traffic information (updated as received from a remote computing device), pullover spots, vegetation, or other such objects and information.

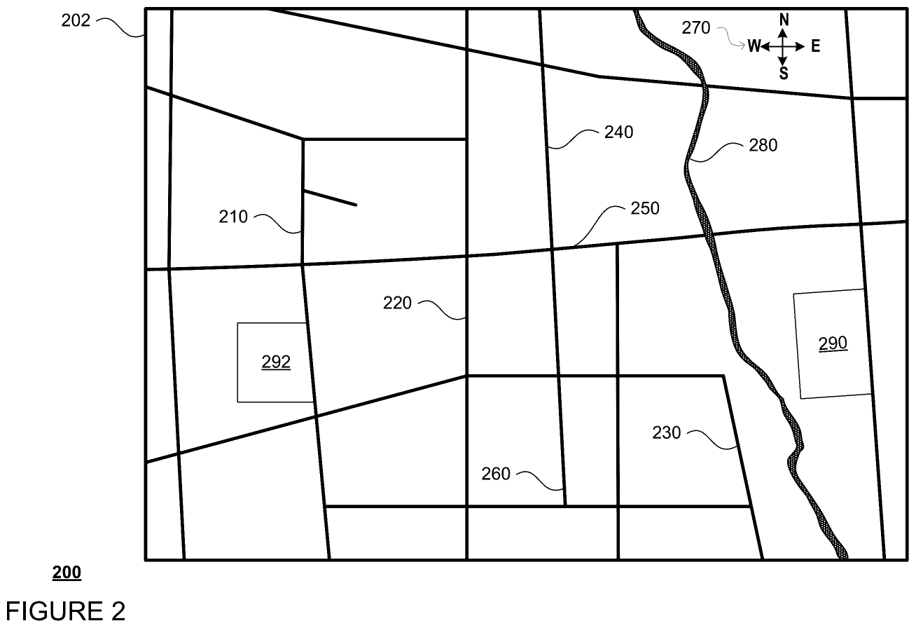

FIG. 2 is an example of portions of the map information for demonstrative purposes. As shown in FIG. 2, the map information 200 includes information identifying the shape, location, and other characteristics of roads and other drivable areas (e.g., parking lots), including roads 210, 220, 230, 240, 250, 260 and others within a geographic area 202. The map information 200 may also include more fine-grained information such as the shape, location and other characteristics of lane markers, lane lines curbs or other road edges which define the shape, location and other characteristics of lanes, traffic control devices such as yield signs, traffic lights, and stop signs, as well as various other features. Such detail is not depicted in the map information 200 for ease of understanding. Compass 270 provides a directional arrow for reference only and need not necessarily be included in the map information as such. However, in addition to these features, the map information may also include information that identifies the direction of traffic and speed limits for each lane or other drivable area as well as information that allows the computing devices 110 to determine whether the autonomous vehicle has the right of way to complete a particular maneuver (i.e. complete a turn or cross a lane of traffic or intersection), as well as other features such as buildings, waterways (such as waterway 280), vegetation, signs, and depot areas 290, 292 etc.

The map information may be configured as a roadgraph. The roadgraph may include a plurality of graph nodes and edges representing features such as crosswalks, traffic lights, road signs, road or lane segments, etc., that together make up the road network of the map information. Each edge is defined by a starting graph node having a specific geographic location (e.g. latitude, longitude, altitude, etc.), an ending graph node having a specific geographic location (e.g. latitude, longitude, altitude, etc.), and a direction. This direction may refer to a direction the autonomous vehicle 100 must be moving in in order to follow the edge (i.e. a direction of traffic flow). The graph nodes may be located at fixed or variable distances. For instance, the spacing of the graph nodes may range from a few centimeters to a few meters and may correspond to the speed limit of a road on which the graph node is located. In this regard, greater speeds may correspond to greater distances between graph nodes. The edges may represent driving along the same lane or changing lanes. Each node and edge may have a unique identifier, such as a latitude and longitude location of the node or starting and ending locations or nodes of an edge. In addition to nodes and edges, the map may identify additional information such as types of maneuvers required at different edges as well as which edges or lanes or other mapped areas are drivable.

The routing system 166 may use the aforementioned map information to determine a route from a current location (e.g. a location of a current node) to a destination. Routes may be generated using a cost-based analysis which attempts to select a route to the destination with the lowest cost. Costs may be assessed in any number of ways such as time to the destination, distance traveled (each edge may be associated with a cost to traverse that edge), types of maneuvers required, convenience to passengers or the autonomous vehicle, etc. Each route may include a list of a plurality of nodes and edges which the autonomous vehicle can use to reach the destination. Routes may be recomputed periodically as the autonomous vehicle travels to the destination.

The map information used for routing may be the same or a different map as that used for planning trajectories. For example, the map information used for planning routes not only requires information on individual lanes, but also the nature of lane boundaries (e.g., solid white, dash white, solid yellow, etc.) to determine where lane changes are allowed. However, unlike the map used for planning trajectories, the map information used for routing need not include other details such as the locations of crosswalks, traffic lights, stop signs, etc., though some of this information may be useful for routing purposes. For example, between a route with a large number of intersections with traffic controls (such as stop signs or traffic signal lights) versus one with no or very few traffic controls, the latter route may have a lower cost (e.g. because it is faster) and therefore be preferable.

Positioning system 170 may be used by computing devices 110 in order to determine the autonomous vehicle's relative or absolute position on a map or on the earth. For example, the positioning system 170 may include a GPS receiver to determine the device's latitude, longitude and/or altitude position. Other location systems such as laser-based localization systems, inertial-aided GPS, or camera-based localization may also be used to identify the location of the autonomous vehicle. The location of the autonomous vehicle may include an absolute geographical location, such as latitude, longitude, and altitude, a location of a node or edge of the roadgraph as well as relative location information, such as location relative to other cars immediately around it, which can often be determined with less noise than the absolute geographical location.

The positioning system 172 may also include other devices in communication with computing devices 110, such as an accelerometer, gyroscope or another direction/speed detection device to determine the direction and speed of the autonomous vehicle or changes thereto. By way of example only, an acceleration device may determine its pitch, yaw or roll (or changes thereto) relative to the direction of gravity or a plane perpendicular thereto. The device may also track increases or decreases in speed and the direction of such changes. The device's provision of location and orientation data as set forth herein may be provided automatically to the computing device 110, other computing devices and combinations of the foregoing.

The perception system 174 also includes one or more components for detecting objects external to the autonomous vehicle such as other road users (vehicles, pedestrians, bicyclists, etc.) obstacles in the roadway, traffic signals, signs, trees, buildings, etc. For example, the perception system 174 may include Lidars, sonar, radar, cameras, microphones and/or any other detection devices that generate and/or record data which may be processed by the computing devices of computing devices 110. In the case where the autonomous vehicle is a passenger vehicle such as a minivan or car, the autonomous vehicle may include Lidar, cameras, and/or other sensors mounted on or near the roof, fenders, bumpers or other convenient locations.

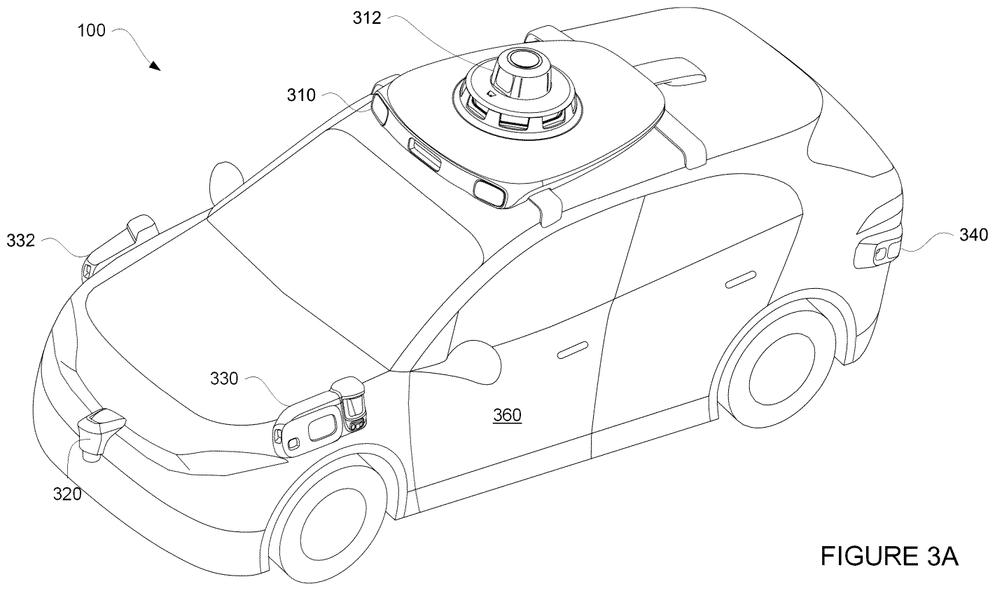

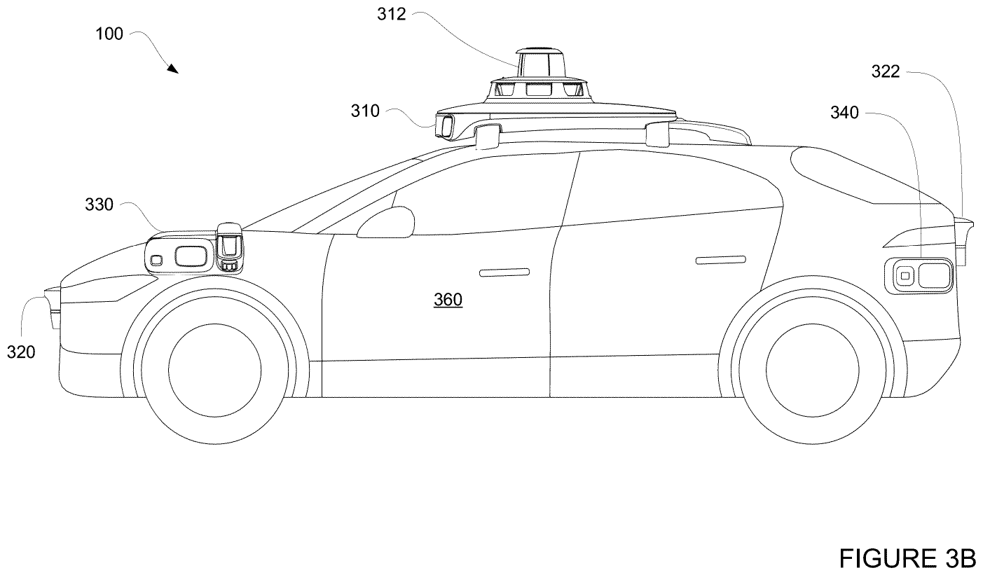

For instance, FIGS. 3A-3B are an example external views of autonomous vehicle 100. In this example, roof-top housing 310 and upper housing 312 may include a LIDAR sensor as well as various cameras and radar units. Upper housing 312 may include any number of different shapes, such as domes, cylinders, “cake-top” shapes, etc. In addition, housing 320, 322 (shown in FIG. 3B) located at the front and rear ends of autonomous vehicle 100 and housings 330, 332 on the driver's and passenger's sides of the autonomous vehicle may each store a Lidar sensor and, in some instances, one or more cameras. For example, housing 330 is located in front of driver door 360. Autonomous vehicle 100 also includes a housing 340 for radar units and/or cameras located on the driver's side of the autonomous vehicle 100 proximate to the rear fender and rear bumper of autonomous vehicle 100. Another corresponding housing (not shown may also be arranged at the corresponding location on the passenger's side of the autonomous vehicle 100. Additional radar units and cameras (not shown) may be located at the front and rear ends of autonomous vehicle 100 and/or on other positions along the roof or roof-top housing 310.

Computing devices 110 may be capable of communicating with various components of the autonomous vehicle in order to control the movement of autonomous vehicle 100 according to primary vehicle control code of memory of computing devices 110. For example, returning to FIG. 1, computing devices 110 may include various computing devices in communication with various systems of autonomous vehicle 100, such as deceleration system 160, acceleration system 162, steering system 164, signaling system 166, forward planning system 168, routing system 170, positioning system 172, perception system 174, behavior modeling system 176, and power system 178 (i.e. the autonomous vehicle's engine or motor) in order to control the movement, speed, etc. of autonomous vehicle 100 in accordance with the instructions 134 of memory 130.

The various systems of the autonomous vehicle may function using autonomous vehicle control software in order to determine how to control the autonomous vehicle. As an example, a perception system software module of the perception system 174 may use sensor data generated by one or more sensors of an autonomous vehicle, such as cameras, Lidar sensors, radar units, sonar units, etc., to detect and identify objects and their characteristics. These characteristics may include location, type, heading, orientation, speed, acceleration, change in acceleration, size, shape, etc.

In some instances, characteristics may be input into a behavior prediction system software module of the behavior modeling system 176 which uses various behavior models based on object type to output one or more behavior predictions or predicted trajectories for a detected object to follow into the future (e.g. future behavior predictions or predicted future trajectories). In this regard, different models may be used for different types of objects, such as pedestrians, bicyclists, vehicles, etc. The behavior predictions or predicted trajectories may be a list of positions and orientations or headings (e.g. poses) as well as other predicted characteristics such as speed, acceleration or deceleration, rate of change of acceleration or deceleration, etc.

In other instances, the characteristics from the perception system 174 may be put into one or more detection system software modules, such as a traffic light detection system software module configured to detect the states of known traffic signals, construction zone detection system software module configured to detect construction zones from sensor data generated by the one or more sensors of the autonomous vehicle as well as an emergency vehicle detection system configured to detect emergency vehicles from sensor data generated by sensors of the autonomous vehicle. Each of these detection system software modules may use various models to output a likelihood of a construction zone or an object being an emergency vehicle.

Detected objects, predicted trajectories, various likelihoods from detection system software modules, the map information identifying the autonomous vehicle's environment, position information from the positioning system 170 identifying the location and orientation of the autonomous vehicle, a destination location or node for the autonomous vehicle as well as feedback from various other systems of the autonomous vehicle may be input into a planning system software module of the planning system 168. The planning system 168 may use this input to generate planned trajectories for the autonomous vehicle to follow for some brief period of time into the future based on a route generated by a routing module of the routing system 170. Each planned trajectory may provide a planned path and other instructions for an autonomous vehicle to follow for some brief period of time into the future, such as 10 seconds or more or less. In this regard, the trajectories may define the specific characteristics of acceleration, deceleration, speed, direction, etc. to allow the autonomous vehicle to follow the route towards reaching a destination. A control system software module of computing devices 110 may be configured to control movement of the autonomous vehicle, for instance by controlling braking, acceleration and steering of the autonomous vehicle, in order to follow a trajectory.

The computing devices 110 may control the autonomous vehicle in one or more of the autonomous driving modes by controlling various components. For instance, by way of example, computing devices 110 may navigate the autonomous vehicle to a destination location completely autonomously using data from the detailed map information and planning system 168. Computing devices 110 may use the positioning system 170 to determine the autonomous vehicle's location and perception system 174 to detect and respond to objects when needed to reach the location safely. Again, in order to do so, computing device 110 and/or planning system 168 may generate trajectories and cause the autonomous vehicle to follow these trajectories, for instance, by causing the autonomous vehicle to accelerate (e.g., by supplying fuel or other energy to the engine or power system 178 by acceleration system 162), decelerate (e.g., by decreasing the fuel supplied to the engine or power system 178, changing gears, and/or by applying brakes by deceleration system 160), change direction (e.g., by turning the front or rear wheels of autonomous vehicle 100 by steering system 164), and signal such changes (e.g., by lighting turn signals) using the signaling system 166. Thus, the acceleration system 162 and deceleration system 160 may be a part of a drivetrain that includes various components between an engine of the autonomous vehicle and the wheels of the autonomous vehicle. Again, by controlling these systems, computing devices 110 may also control the drivetrain of the autonomous vehicle in order to maneuver the autonomous vehicle autonomously.

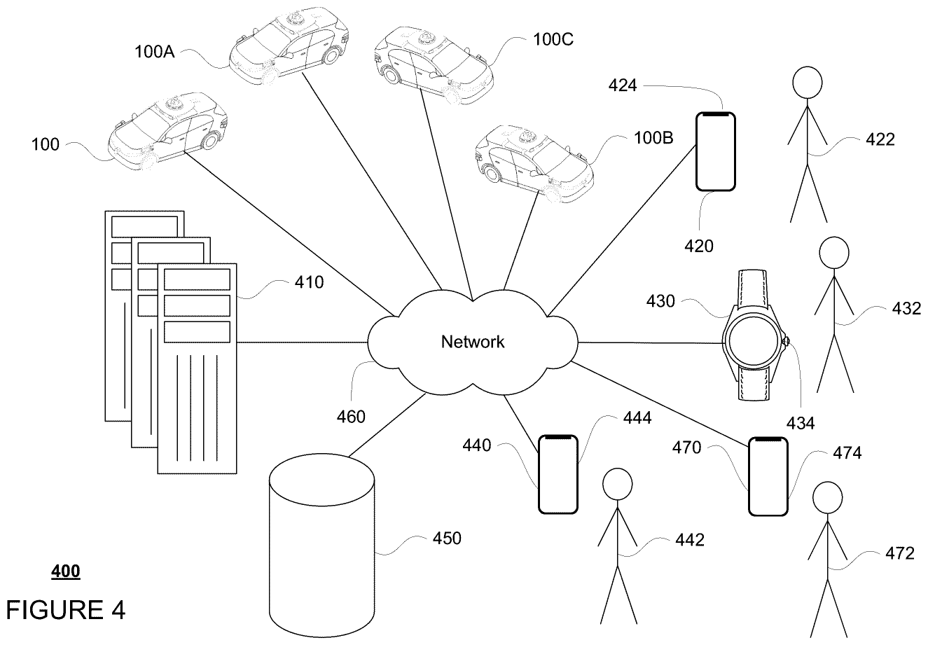

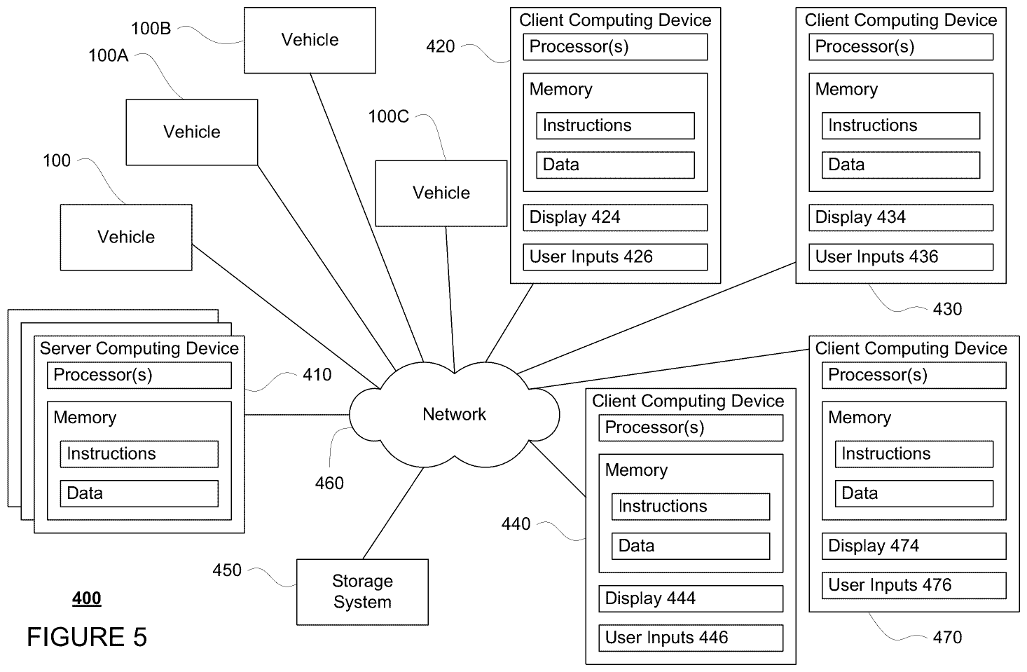

Computing device 110 of autonomous vehicle 100 may also receive or transfer information to and from other computing devices, such as those computing devices that are a part of the transportation service as well as other computing devices. FIGS. 4 and 5 are pictorial and functional diagrams, respectively, of an example system 400 that includes a plurality of computing devices 410, 420, 430, 440, 470 and a storage system 450 connected via a network 460. System 400 also includes autonomous vehicles 100A, 100B and 100C, which may be configured the same as or similarly to autonomous vehicle 100. Although only a few vehicles and computing devices are depicted for simplicity, a typical system may include significantly more.

As shown in FIG. 5, each of computing devices 410, 420, 430, 440, 470 may include one or more processors, memory, data and instructions. Such processors, memories, data and instructions may be configured similarly to one or more processors 120, memory 130, data 132, and instructions 134 of computing device 110.

The network 460, and intervening nodes, may include various configurations and protocols including short range communication protocols such as Bluetooth, Bluetooth LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

In one example, one or more computing devices 410 may include one or more server computing devices having a plurality of computing devices, e.g., a load balanced server farm, that exchange information with different nodes of a network for the purpose of receiving, processing and transmitting the data to and from other computing devices. For instance, one or more computing devices 410 may include one or more server computing devices that are capable of communicating with computing device 110 of autonomous vehicle 100 or a similar computing device of autonomous vehicle 100A, 100B, 100C as well as computing devices 420, 430, 440, 470 via the network 460. For example, autonomous vehicles 100, 100A, 100B, 100C may be a part of a fleet of vehicles that can be dispatched by server computing devices to various locations.

In this regard, the server computing devices 410 may function as a fleet management system which can be used to track the status of autonomous vehicles of the fleet and arrange trips for passengers by assigning and dispatching vehicles such as autonomous vehicles 100, 100A, 100B, 100C. These assignments may include scheduling trips to different locations in order to pick up and drop off those passengers. In this regard, the server computing devices 410 may operate using scheduling system software in order to manage the aforementioned autonomous vehicle scheduling and dispatching. In addition, the computing devices 410 may use network 460 to transmit and present information to a user, such as user 422, 432, 442 on a display, such as displays 424, 434, 444 of computing devices 420, 430, 440, 470. In this regard, computing devices 420, 430, 440 may be considered client computing devices.

As shown in FIG. 3, each client computing device 420, 430, 440, 470 may be a personal computing device intended for use by a user 422, 432, 442, 472 and have all of the components normally used in connection with a personal computing device including a one or more processors (e.g., a central processing unit (CPU)), memory (e.g., RAM and internal hard drives) storing data and instructions, a display such as displays 424, 434, 444, 474 (e.g., a monitor having a screen, a touch-screen, a projector, a television, or other device that is operable to display information), and user input devices 426, 436, 446, 476 (e.g., a mouse, keyboard, touchscreen or microphone). The client computing devices may also include a camera for recording video streams, speakers, a network interface device, and all of the components used for connecting these elements to one another.

Although the client computing devices 420, 430, 440, 470 may each comprise a full-sized personal computing device, they may alternatively comprise mobile computing devices capable of wirelessly exchanging data with a server over a network such as the Internet. By way of example only, client computing device 420, 440, 470 may be a mobile phone or a device such as a wireless-enabled PDA, a tablet PC, a wearable computing device or system, or a netbook that is capable of obtaining information via the Internet or other networks. In another example, client computing device 430 may be a wearable computing system, such as a wristwatch as shown in FIG. 3. As an example the user may input information using a small keyboard, a keypad, microphone, using visual signals with a camera, or a touch screen. As yet another example, a client computing device may be a desktop computing system including a keyboard, mouse, camera and other input devices.

In some examples, client computing device 420 may be a mobile phone used by a passenger of a vehicle. In other words, user 422 may represent a passenger. In addition, client computing device 430 may represent a smart watch for a passenger of a vehicle. In other words, user 432 may represent a passenger. The client computing device 440 may represent a workstation for a human operator, for example, personnel of a depot area (as discussed further below), a remote assistance operator, a technician who provides roadside assistance, or someone who may otherwise provide assistance to an autonomous vehicle and/or a passenger. In other words, user 442 may represent an operator (e.g. operations person) of a transportation service utilizing the autonomous vehicles 100, 100A, 100B, 100C. Although only a few passengers and human operators are shown in FIGS. 4 and 5, any number of such passengers and human operators (as well as their respective client computing devices) may be included in a typical system.

As with memory 130, storage system 450 can be of any type of computerized storage capable of storing information accessible by the server computing devices 410, such as a hard-drive, memory card, ROM, RAM, DVD, CD-ROM, write-capable, and read-only memories. In addition, storage system 450 may include a distributed storage system where data is stored on a plurality of different storage devices which may be physically located at the same or different geographic locations. Storage system 450 may be connected to the computing devices via the network 460 as shown in FIGS. 3 and 4, and/or may be directly connected to or incorporated into any of computing devices 110, 410, 420, 430, 440, etc. Storage system 450 may store various types of information which may be retrieved or otherwise accessed by a server computing device, such as the one or more server computing devices 410, in order to perform all or some of the features described herein.

### Example Methods

In addition to the operations described above and illustrated in the figures, various operations will now be described. It should be understood that the following operations do not have to be performed in the precise order described below. Rather, various steps can be handled in a different order or simultaneously, and steps may also be added or omitted.

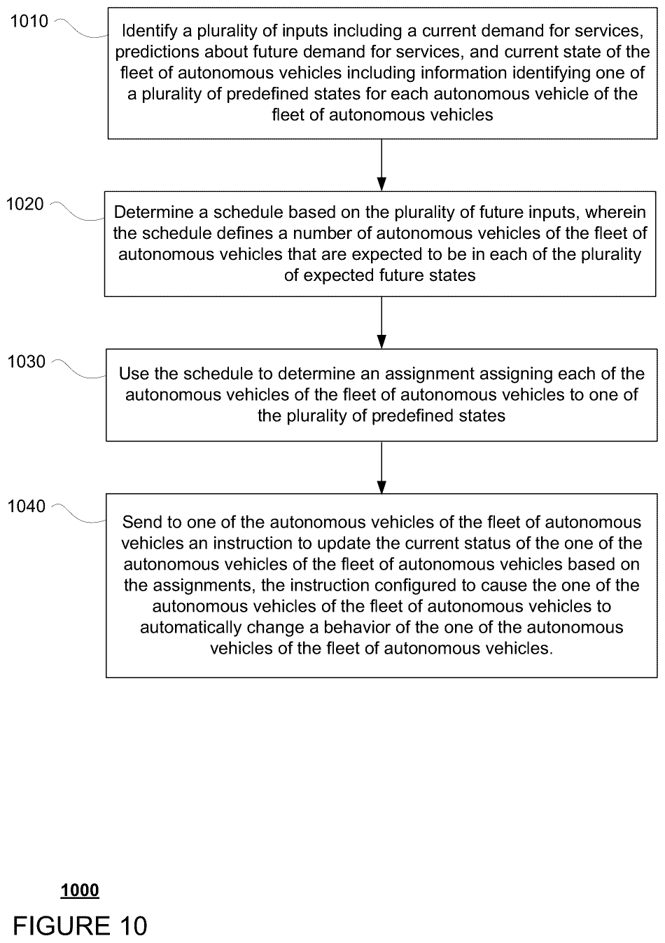

FIG. 10 is an example flow diagram 1000 depicting an example method for managing a fleet of autonomous vehicles of a transportation service, which may be performed by one or more processors, such as the one or more processors of the server computing devices 410. In this example, at block 1010, a plurality of inputs, including a current demand for services, predictions about future demand for services, and current state of the fleet of autonomous vehicles, are identified. In this example, the current state of the fleet of autonomous vehicles includes information identifying one of a plurality of predefined states for each autonomous vehicle of the fleet of autonomous vehicles.

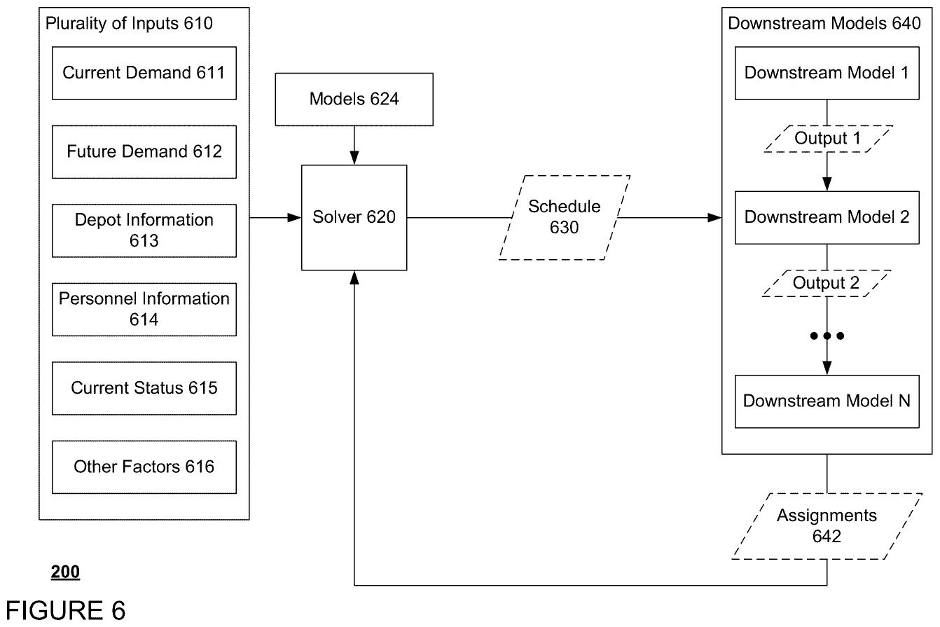

FIG. 6 depicts an example visual representation of a process for managing a fleet of autonomous vehicles of a transportation service. For instance, the server computing devices 410 may first identify a plurality of inputs 610. These inputs may include current demand for services 611, predictions about future demand for services 612, depot information 613, personnel information 614 including current and future numbers of personnel and skills, qualifications or capabilities of personnel, the current status 615 of each autonomous vehicle of the fleet of autonomous vehicles, and other factors 616.

Current demand for services 611 may include information such as the number and approximate location of users who currently have an application for the transportation service open, and in some instances have also entered a location such as a pickup location and/or a destination for a trip, events currently taking place (e.g., a concert, sporting or other event, etc.), as well as the number of requests for transportation of passengers or goods or other services currently received.

Predictions about future demand for services 612 may include volume and location of demand. These predictions may be made by the server computing devices 410 or another computing device based on historical demand for transportation services (e.g., the number of requests for trips received over the same or similar period of time in the past), known future events (e.g., a concert, sporting, or other event, etc.) which may increase or decrease the expected number of people needing trips in a given area, current and future weather information (as this may impact demand), and other information. In some instances, future demand may be predicted using machine-learned models which take current and historical demand as inputs in order to generate expected rates of future demand at different points in time.

Depot information 613 may include locations, capabilities, and status of each of the depot areas. The status of each depot area may include the number of parking spots, number of parking spots available or occupied, traffic capacity (e.g., the maximum entry and exit rates of a depot location), number of chargers, charge rates of such chargers, number of chargers available or in use, availability of other technical troubleshooting, or maintenance services etc. The traffic capacity may be fixed limits hand-selected for the system or alternatively may be learned over time. As an example, a fixed limit may involve limiting the number of incoming vehicles during a period of time (e.g., no more than 1 vehicle in 10 minutes at depot location 1, and no more than 2 vehicles in 10 minutes at depot location 2, and so on). Of course, more complex limits may also be used.

In some instances, the depot information (or potentially, other factors 616) may include information about the cost of energy for charging as well as how the cost may fluctuate according to time of year or even time of day. For instance, the cost of electricity in a first depot location may be one value (e.g., $X) from midnight to 5 AM and another value (e.g., $Y) for the rest of the day, whereas the cost of electricity may be a third value (e.g., $Z) for the entire day. Modeling this difference in cost may allow the transportation system to be even more efficient with scheduling.

The personnel information 614 may include information related to personnel at the depots. These personnel may be persons who provide or otherwise enable maintenance at the depots. For example, these persons may connect a charger to a charging port of an autonomous vehicle, provide internal or external cleaning services, swap memory devices, change tires, change oil, or provide various other maintenance services required to maintain the autonomous vehicles. Some personnel may only have some skills, qualifications or capabilities. For example, some personnel may be able to change oil while other personnel may be able to swap memory devices. The current number of personnel may simply correspond to the number of personnel who are currently working at the depots and not taking a break. The future number of personnel may be determined based on work schedules (e.g., shift, absences, and break information).

For example, in order to determine a current state of the fleet of autonomous vehicles, the server computing devices 410 may aggregate the current status 615 of each autonomous vehicle of the fleet of autonomous vehicles. The current status 615 of each autonomous vehicle may include information such as location, current destination, current route, whether the vehicle is transporting passengers or goods, information about the status of the autonomous vehicles' various systems (e.g., state of charge or fuel, fluids, mileage, etc.), and information identifying (e.g., a state identifier such as a code or string of alphanumeric text) one of a plurality of predefined states. This information may be reported to the fleet management periodically by the autonomous vehicles in state messages. In some instances, this may include whether the autonomous vehicle 100 is currently servicing a trip, charge or fuel status, whether the autonomous vehicle needs sensors cleaned (e.g., it has been X amount of time since last cleaning or this sensor is determined to have some sort of fouling), memory capacity for a memory device (e.g., for recording log data), tire pressure, etc. In addition, the computing devices of these autonomous vehicles (e.g., computing devices 110) may also provide information identifying one of a plurality of predefined states. Alternatively, these predefined states may be assigned by the server computing devices 410 and tracked via a table or other device in the storage system 450.

Examples of such predefined states may include, for example, “off”, “in service”, “return to depot” (or base), “maintenance”, “on and ready to be launched”, and “waiting for next trip”. Of course, depending upon the configuration of the transportation system, additional or different states may also be used. As an example, if an autonomous vehicle's status is “off” this may indicate that the autonomous vehicle is currently off and likely parked at a depot location or other location. If an autonomous vehicle is “in service”, the autonomous vehicle may be either driving to (e.g., driving to pick up passengers or goods) or currently providing transportation services for passengers or goods or potentially other services. If an autonomous vehicle is “waiting for next trip”, or the autonomous vehicle may be driving empty (e.g., no passengers or goods) to a place to stop and wait (e.g., a parking spot, parking lot, depot or other location) or parked and waiting for the next trip or destination instructions. In some instances, when vehicles have no specific needs and/or are not required to meet demand, or there is a period of time during which there is lowered or lack of demand for transportation services, the autonomous vehicles may be in the “on and ready to be launched” state. In this state, an autonomous vehicle may be sent to a depot area, parking lot, or other location with parking spaces to wait to receive an updated state. For instance, such vehicles may be fully or close to fully charged and waiting at a depot to be put into another state such as “waiting for next trip” or “in service”. If an autonomous vehicle is “return to depot”, the autonomous vehicle's status may be on its way to a depot location. In some instances, this state may be used when an autonomous vehicle is going to receive maintenance or is going to wait for further instructions (e.g., put into the “on and ready to be launched” state. If an autonomous vehicle's status is “maintenance” the autonomous vehicle may be receiving maintenance, including, for example, charging, cleaning (internal or external), swapping out a memory device, etc. In this regard, once the desired maintenance is completed, an autonomous vehicle may be put into the “in service” or “waiting for next trip” state immediately after the “maintenance” state. Alternatively, if not required for providing services, the autonomous vehicle may be put into the “on and ready to be launched state” immediately after the “maintenance” state.

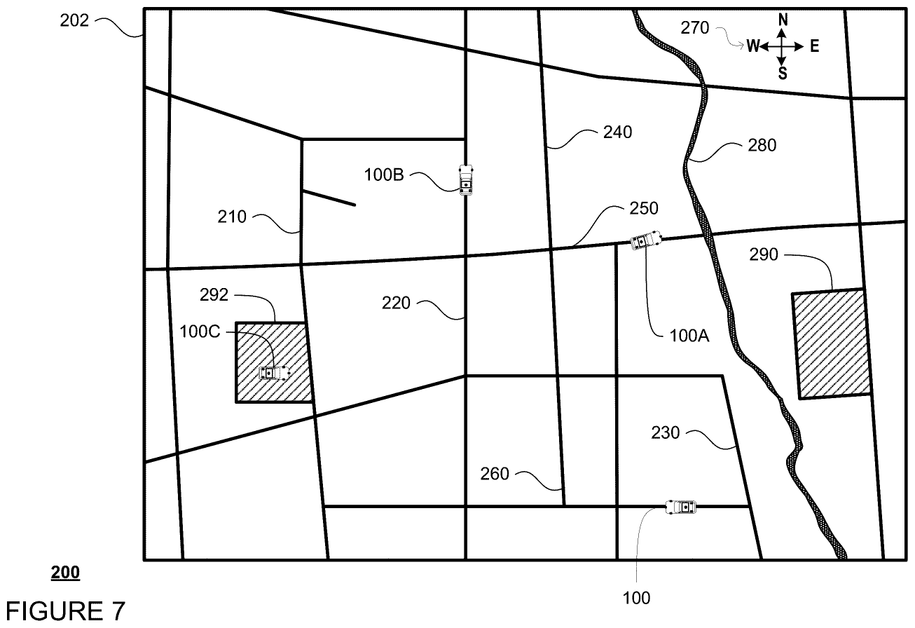

FIG. 7 is an example of the map information 200 of FIG. 2A identifying the current locations of the autonomous vehicles 100, 100A, 100B, 100C of the fleet of autonomous vehicles. In this example, autonomous vehicles 100, 100A, 100B are driving around and autonomous vehicle 100C is parked in depot area 292. Although only a few autonomous vehicles are depicted, this is merely for ease of understanding. A fleet of autonomous vehicles may include many tens, hundreds, or thousands of autonomous vehicles.

As noted above, each autonomous vehicle may send state messages which include, among other things, that autonomous vehicle's current location and information identifying one of the aforementioned predefined states. Turning to FIG. 7, each of the autonomous vehicles 100, 100A, 100B, 100C may send a status message 810, 820, 830, 840, respectively to the server computing devices 410. In this example, the status information includes the location of each autonomous vehicle (e.g., X,Y) as well as one of the plurality of predefined states. For example, autonomous vehicles 100, 100B are currently in an “In Service” state. In addition, autonomous vehicle 100A is currently “Return to Depot”, and autonomous vehicle 100C is “Maintenance.” In this example, the current locations and predefined states may have been received by the server computing devices 410 from the respective computing devices of these autonomous vehicles and stored in memory for later use (e.g., memory of the server computing devices 410 and/or storage system 450).

Other predefined states may also be possible depending on the configuration of the transportation system, autonomous vehicles, and/or types of services being provided. For example, an autonomous vehicle may enter a “self-correcting” state where the computing devices of the autonomous vehicle stop the autonomous vehicles and attempt to self-correct issues (e.g., pullover and run diagnostics, turn on and off again, reset some features, etc. in order to avoid the need for another vehicle or technician to meet up with the autonomous vehicle). As another example, maintenance may involve various types of maintenance including charging, cleaning, swapping out a memory device, etc. Thus, in some instances, rather than simply “maintenance”, an autonomous vehicle may be in a state of “charging”, or “cleaning” (e.g., or even more refined such as “internal cleaning” or “external cleaning”), or “memory swap”, etc. or any other state which may be appropriate for an autonomous vehicle at a depot. Each of these sub-states of maintenance may only be actioned up in specific depots by personnel with specific skills, qualifications, or capabilities. In some instances, the autonomous vehicle may only be in a single state at one time.

The plurality of inputs may also include other factors 616. For example, the plurality of inputs may also include factors more directly related to revenue. In this regard, the plurality of inputs may include revenue potential of current and future demand. For example, a request for a two-mile trip may have less revenue potential than a request for a 4 mile trip. As another example, a trip ending near a higher-demand area (e.g., a business, shopping or other area with a higher expected demand for transportation services), may have more revenue potential than a trip that ends near a lower-demand area (e.g., a more sparsely-populated or other area with a lower expected demand for transportation services).

Returning to FIG. 10, at block 1020, a schedule is determined based on the plurality of inputs. In this example, the schedule defines a number of autonomous vehicles of the fleet that are predicted to be in each of a plurality of expected future states. In addition, each of the plurality of predicted future states is one of the plurality of predefined states. In this regard, using the solver, the server computing devices 410 may use the current state of the fleet of autonomous vehicles as well as the models to output a schedule including number of vehicles at each timestep which will be in each of the aforementioned states; {#“off”, #“in service”, #“return to depot”, #“maintenance”, #“on and waiting to be launched”, and #“waiting for next trip”}.

For example, as shown in FIG. 6, the plurality of inputs 610 as well as outputs of the models 624 are input into a solver 620, for instance by the server computing devices 410. This solver 620 may include an integer programming package such as those used in operations research, and for example, CP-SAT Solver from GOOGLE INC. Of course, other linear programming solvers or a machine-learning approach may alternatively be used.

For instance, using the current state of the fleet of autonomous vehicles as well as the output of models 624, the server computing devices 410 may determine the aggregate status of the fleet of autonomous vehicles at a plurality of future timesteps (e.g., timestep T=1, timestep T=2 . . . timestep T=N). As an example, the server computing devices 410 may determine a predicted number of autonomous vehicles in each of the predetermined states for every 10 (or more or less minutes) for the next 8, 12, or 24 hours or more or less as discussed further below.

The server computing devices 410 may optimize for different “goals” or variables of interest. Such variables may include maximizing the number of trips (e.g., at each timestep or during a particular period of time), maximizing revenue and/or profits, minimizing estimated times of arrival for pickups and/or drop offs, etc. In order to optimize for a variable of interest, an objective function or optimization model that the fleet management system tries to optimize may be defined. In order to incorporate this “goal” into an optimization model, the variable of interest may be approximated by a piecewise linear model. As an example, if trying to maximize trips, a model of total trips as a function of current or future demand at each timestep and the number of “in service” vehicles. The current or future demand may be predicted using various models as discussed above. As another example, if trying to maximize revenue and/or profits, this model may approximate the value of “in service” vehicles at different times of the day and properties of these vehicles (such as location and state of charge). In addition or alternatively, this model may also incorporate costs such as driving costs and operational costs.

The server computing devices 410 may use the model to determine the number of vehicles that are put “in service” at a timestep will result in some number of trips at each later timestep. Using this information, the server computing devices 410 may determine how many vehicles to put “in service”, subject to constraints, at each timestep in order to maximize the total number of trips (e.g., for the next 8, 12, or 14 hours or more or less. As an example, the constraints may correspond to one or more of the plurality of inputs 610, including, for example, the depot information 613, personnel information 614, current status 615, and other factors, etc. as discussed above.

Table 1 below provides a simplified example of a schedule providing a number of vehicles in each of the aforementioned states at a plurality of timesteps. In this example, T=0 represents the current state of the transportation system, and T=1, T=2, T=3 each represent future timesteps (T=3 being later than T=2, T=2 being later than T=1, T=1 being later than T=0). As an example, these timesteps may represent points in time that are 10 minutes or more or less apart from one another. In this example, the total number of “available” vehicles (e.g., the size of the fleet of autonomous vehicles) at each of the timesteps (here 40) remains constant, though if additional states are used (e.g., “not available for any state” such as for long term service or if a vehicle is completely taken out of service), a vehicle is removed from the fleet of autonomous vehicles, or a new vehicle is added to the fleet of autonomous vehicles at a current or future timestep, this number may change. In addition, Table 1 may represent a single “service area” for a transportation service, the server computing devices 410 may provide a schedule for any number of different service areas.

| States | T = 0 (current) | T = 1 | T = 2 | T = 3 |
|---|---|---|---|---|
| Off | 6 | 3 | 3 | 1 |
| In Service | 25 | 28 | 29 | 30 |
| Return to | 2 | 3 | 1 | 3 |
| Depot | | | | |
| Maintenance | 5 | 7 | 5 | 3 |
| On and waiting | 2 | 0 | 2 | 3 |
| to be launched | | | | |
| Waiting for | 5 | 4 | 4 | 4 |
| next trip | | | | |

While, in some instances, the server computing devices 410 may output instructions for a few specific vehicles, the server computing devices 410 may more efficiently process the current state of the fleet of autonomous vehicles and the models if the output is more generalized as depicted in Table 1 above. In order to do so, some aspects of the system, such as when a given autonomous vehicle is likely to run out of charge and when a given autonomous vehicle is likely to next require maintenance may be modeled, for example, mathematically. In this regard, various models may be used by the server computing devices 410 to make predictions. As shown in FIG. 7, the output of such models 624 may be used by the server computing devices 410 in order to generate the schedule 630. These models may be stored in the memory of the server computing devices 410 and/or storage system 450.

The modeling may involve looking at historical data for the autonomous vehicles and generating predictive models. As an example, with regard to estimating future charging needs, the simplest models may take into consideration an amount of time that a vehicle is driven and expected loss of charge or fuel. As another example, more complex models may take into consideration additional features such as the type of vehicle (e.g., sedan, minivan, tractor-trailer, etc.), weight, number of trips or services provided, number of miles driven, hardware and software configurations, weather and/or temperature (which may affect charging speeds as well as battery depletion rates), driving speeds, air conditioning use, etc. Such models may even involve training machine learned models trained on historical battery discharge rates and any or all of the aforementioned features. Of course, this modeling will be specific to each transportation service, the types of services provided, and the types of autonomous vehicles of the fleet. The resulting models may then be used by the server computing devices 410 to generate the plurality of predicted future states.

In some instances, determining the predicted future states of the fleet of autonomous vehicles may also involve estimating how long an autonomous vehicle will spend in its current state. These estimates may then be used by the server computing devices 410 to generate the plurality of predicted future states.

In some instances, the amount of time that an autonomous vehicle may remain “in service” or “charging” may be based on historical averages for such predefined states. In other instances, these may be modeled more particularly. For example, the amount of time a vehicle may remain “in service” may be modeled based on current utilization rates, ambient temperature, or other factors. As another example, vehicle charge time may be modeled based on ambient temperature, charger equipment specifications, total power available in the depot, and, in some instances, time of day and its relationship to electricity costs. Another factor that determines the future “charging” state is the availability of free chargers at various depot locations. This future-time estimate of charger availability, serviceability, and count may be provided by a “resource tracking service” which maintains real time information about each charger in the network.

In other instances, the amount of time that an autonomous vehicle may remain in certain states may be based on fixed or more complex values. As an example, an amount of time for a vehicle to transition from “return to depot” to “maintenance” or other related status identifier may be a fixed value (e.g., an average of 20 minutes) or may be determined based on vehicle location (e.g., estimating how long the autonomous vehicle will take to reach a closet or an assigned depot based on the autonomous vehicle's current location, traffic information, map information, etc.).

As another example, the amount of time that an autonomous vehicle is “off” may depend not only on when it is expected to be needed to provide services but also how long it takes for the autonomous vehicle to transition between states and the existence of any maintenance requests for the autonomous vehicle that can only be performed in the “off” state. For example, an autonomous vehicle may require some amount of time to transition between being off and being ready to go “on and staged” or “in service” (e.g., an average “launch” time). Estimating this amount of time may involve estimating values from recent data from this or other autonomous vehicles to turn on, be tested, have any necessary maintenance performed, and be ready to engage an autonomous driving mode.

As another example, the amount of time a vehicle will take to transition from “maintenance” or “in service” or “on and staged” to “off” may be based on the expected time required to shut down the autonomous vehicle.

As noted above, using the solver 620, the resulting current state of the fleet of autonomous vehicles as well as the models may then be used by the server computing devices 410 to determine a schedule. This schedule may define what the future state of the fleet of autonomous vehicles should look like at each timestep or the number of vehicles that will be in each of the plurality of predefined states. In addition to this, in some instances, the schedule may also include utilization rates for different resources such as chargers, personnel, parking spaces, etc. As an example a utilization rate may include “3 of 5 chargers will be utilized at 3 PM” or “no more than 2 out of 3 staff will be utilized from 12 PM to 3 PM”. This in turn can be used to improve the planning of resource allocation.

Returning to FIG. 10, at block 1030, the schedule is used to determine an assignment assigning each of the autonomous vehicles of the fleet of autonomous vehicles to one of the plurality of predefined states. For instance, the schedule, including, number of autonomous vehicles of the fleets in each of predefined states at each timestep, may be input by the server computing devices 410 into various downstream models for assigning specific vehicles to specific ones of the plurality of predefined states. As an example, returning to FIG. 6, the schedule 630 may be input into each of a plurality of downstream models 640 including downstream models 1, 2, and N. In this regard, although only 3 downstream models are depicted, any number of downstream models may be used.

The server computing devices 410 may use these downstream models to identify which autonomous vehicles should be assigned to what states and as such which autonomous vehicles need to be reassigned to new states. By doing so, there may be greater flexibility of optimization, planning and execution because each of these downstream models may be more specialized. This may limit the complexity in the determination of the schedule, the solver complexity, and latency requirements (e.g., reduce the amount of time to determine the assignments) and make the system more robust.

For example, the server computing devices 410 may not choose a specific charging spot for a specific autonomous vehicle to charge at a specific time all in one step (e.g., all at the solver 620 of FIG. 6). Instead, the server computing devices 410 may specify, for example, that “2 autonomous vehicles with about 30% charge to send to charge at DEPOT A around 2 pm.” One or more downstream models may be used to choose the exact autonomous vehicles based on the schedule as well as real time data received from the autonomous vehicles as described above. This downstream model may choose to send the chosen autonomous vehicle to the nearest depot with an available charger, and, in some instances, identify the exact charger to use with inputs from the aforementioned resource tracking service.

The downstream models may run independently of one another each producing an output that identifies which vehicles are assigned to which predefined status. Alternatively, the downstream models may be arranged in a hierarchical structure such that the output of one downstream model may be input with the schedule into additional downstream models in order to determine the aforementioned assignments. As an example, returning to FIG. 6, the schedule 630 may be input into downstream model 1 which generates an output 1. This output 1 is then input, with the schedule 630, into downstream model 2. The downstream model 2 may also generate an output, output 2, which then is input, with the schedule 630, into a next downstream model of the hierarchy. This may continue until the output of the penultimate downstream model is input with the schedule 630 into the downstream model N. The final output may be an assignment 642 identifying each autonomous vehicle in the fleet and one of the predefined states for that autonomous vehicle. This assignment may be a combination of all of the outputs of each of the downstream models 1, 2, N. For example, the plurality of downstream models 640 may be used to determine exactly which of the autonomous vehicles of the fleet should be assigned to “off”, “in service”, “return to depot”, “maintenance”, “on and staged, “waiting for next trip”, and so on. The downstream models may solve for individual states or combinations of states.

Each downstream model may output a set of specific autonomous vehicles and corresponding assignments. These assignments may include the predefined status for each autonomous vehicle. In some instances, the assignments may include additional information such as the identity of a particular depot for “return to depot”, a location for the autonomous vehicle to drive to and wait for “on and staged”, or a destination for the autonomous vehicle if assigned to a particular trip (e.g., for transportation of passengers or goods or other services), or a destination for the autonomous vehicle if instructed to park and wait for the next trip (e.g., for transportation of passengers or goods or other services if “waiting for the next trip”). In some instances, these downstream models may also provide a plan for each autonomous vehicle assigned to a particular state, such as “finish current trip, then return to depot to go off” or “drive to location X and wait further instructions”. The output of one downstream model may then be input with the schedule into the next downstream model according to the hierarchy. As an example, a downstream model may take as input the schedule as well as vehicle states, charge levels, locations, and other vehicle needs, availability of resources like chargers and parking spaces, and geospatial demand forecasts to make decisions on how to assign tasks to each vehicle.

The hierarchy or order of these downstream models may depend upon the configuration and goals of the transportation system. For example, some transportation systems may prioritize the assignment of autonomous vehicles to the status of “in service” in order to prioritize providing services over other of the predefined states. In another scenario, transportation systems may prioritize overall marginal profitability and maximize demand capture when making vehicle assignment decisions. As a third alternative, other transportation systems may prioritize the assignment of autonomous vehicles that are “return to depot” in order to prioritize the maintenance (e.g., charging and other maintenance) over other of the predefined states.

Returning to FIG. 10, at block 1040, based on the assignment, an instruction is sent to one of the autonomous vehicles of the fleet of autonomous vehicles to update the current status of the one of the autonomous vehicles of the fleet of autonomous vehicles based on the assignments. In this example, the instruction is configured to cause the one of the autonomous vehicles of the fleet of autonomous vehicles to automatically change a behavior of the one of the autonomous vehicles of the fleet of autonomous vehicles. For instance, the outputs of all of the downstream models may then be used to send instructions to one or more (e.g., all) of the autonomous vehicles of the fleet. These instructions may cause at least some of the autonomous vehicles to automatically change a behavior of those autonomous vehicles by updating the incumbent or queued task assigned to those autonomous vehicles by updating destinations, rerouting to such new destinations, changing state, accepting trips (e.g., to transport goods or services), returning to depots, park at the nearest parking location, turning on or off, go into low power mode, attempting to stop the autonomous vehicles and self-correct issues (e.g., pullover and run diagnostics, turn on and off again, reset some features, etc. in order to avoid the need for another vehicle or technician to meet up with the autonomous vehicle), etc.

The final assignment or the combined outputs of all of the downstream models may also be used by the server computing devices 410 in a next iteration. For instance, as shown in FIG. 6, the assignment 642 may be input, for example by the server computing devices 410, into the solver 620. Thus, the server computing devices 410 may constantly operate on a feedback loop. In this regard, the server computing devices 410 may use this information to determine the next plurality of inputs and thereafter the new current state of the fleet of autonomous vehicles as well as a plurality of expected future states. This may continue automatically in order to continuously update the schedule and outputs of the downstream models. This whole process may be run periodically, for example, every 1, 10 or 15 minutes or more or less depending on the processing resources of the server computing devices 410 and the time needed to determine the plurality of inputs and generate the output for the downstream models.

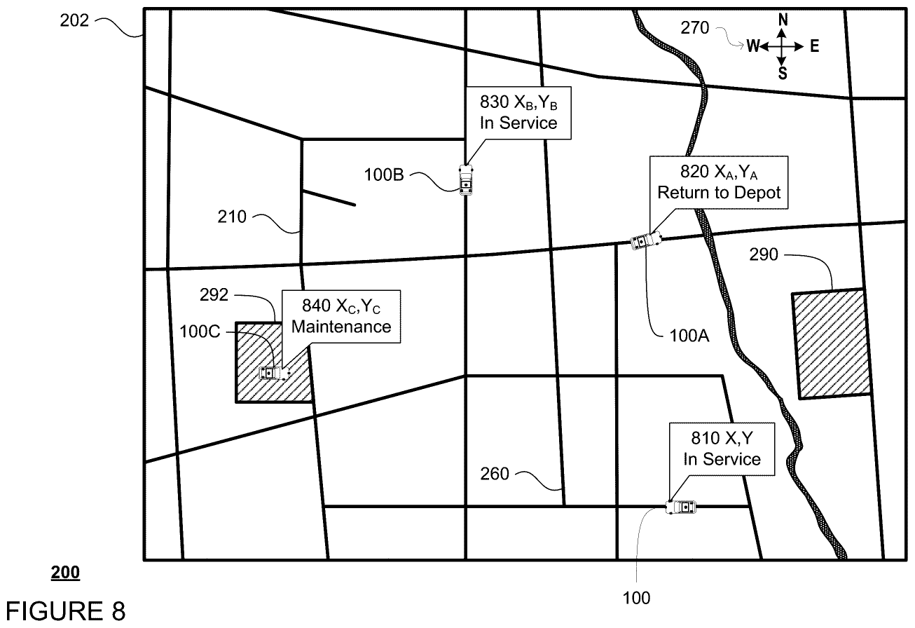

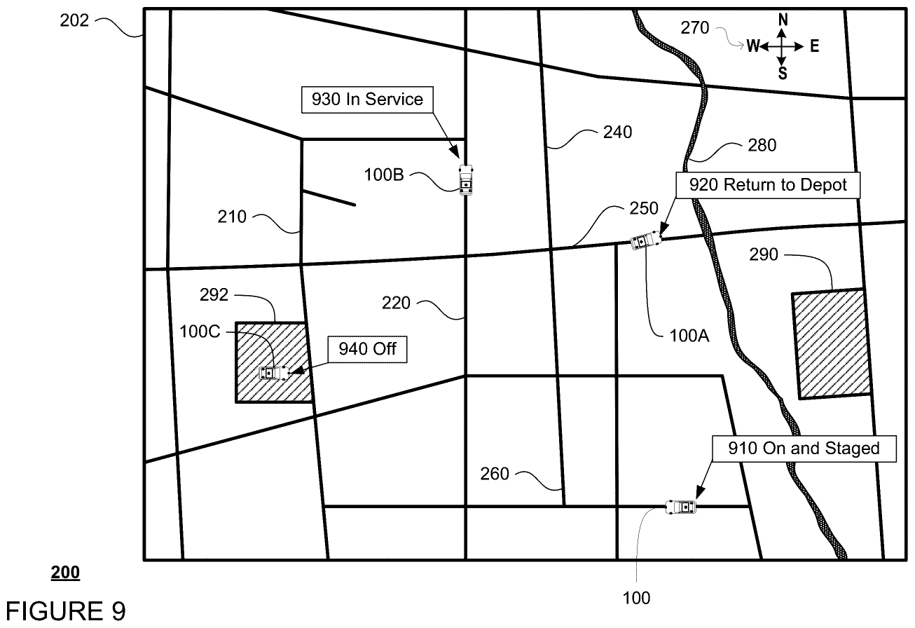

Turning to the example of FIG. 9, the server computing devices 410 may use the assignment 642 to send a plurality of instructions 910, 920, 930, 940 to each of the autonomous vehicles 100, 100A, 100B, 100C, respectively. In this example, instruction 910 may cause the autonomous vehicle 100 to go into the “waiting for next trip” state from the “in service” state as depicted in FIG. 8. For example, the computing device 110 of autonomous vehicle 100 may automatically find a place to stop and wait for further instructions from the server computing devices. Instruction 920 may cause the autonomous vehicle 100A to continue in the “return to depot” state. Instruction 930 may cause the autonomous vehicle 100B to remain in the “in service” state. Instruction 940 may cause the autonomous vehicle to go into the “off” state. For example, the computing device of autonomous vehicle 100C may cause the autonomous vehicle 100C to go into a process for shutting itself down.

At each step in the aforementioned process, the results may be stored (e.g., tracked) by the server computing devices 410. For example, the server computing devices 410 may track and store this information in the storage system 450. In this regard, even if the solver either fails or takes a long time to generate a new schedule, the downstream models may continue to use the last schedule until a new one is available.

In addition, the schedules generated by the server computing devices 410 may be compared to the actual states of the autonomous vehicles of the fleet to determine how the transportation service is performing. For instance, the information provided by the schedule as well as the downstream models (e.g., actual resource allocation) may be compared to actual data to infer how well the autonomous vehicles, demand models, depot equipment, and depot personnel are performing. This, in turn, may allow the transportation service to identify and address potential problem areas or concerns. This evaluation may be performed by the server computing devices 410 and/or another computing system.

For example, the actual number of autonomous vehicles in each state may be compared to the scheduled numbers of vehicles to determine how well the schedules are at predicting realistic outcomes. In this regard, performance of different aspects of the transportation service may be evaluated. As another example, the actual number of autonomous vehicles in-service may be compared to the scheduled number of autonomous vehicles that are in-service at different times of day. Further, the actual outcomes from the vehicles being in each state may be compared to the expected outcomes. For example, the actual number of trips provided at different times of day may be compared to the number of trips from the scheduled number of vehicles in-service. If these values are off (e.g., different) by a certain percentage or factor, this may indicate a problem with the transportation system. As a result, a notification may be generated to initiate an investigation into why the differences are occurring. As another example, comparing states may be used to determine the performance of personnel at depots. As another example, if the schedule indicated that 10 vehicles should transition from “maintenance” to “on and ready to be launched”, i.e. maintenance completed, between 3:00 PM and 3:20 PM at depot A, but only 5 vehicles underwent this transition, this may indicate that more personnel are needed at that time or that there was some source operational inefficiency that hindered the staff at the depot from performing as expected. As another example, if charging times are increasing, this may indicate that the charging equipment may not be performing as expected. As yet another example, if the amount of charge as autonomous vehicles leave depots is below expectation, this may indicate a potential problem in the training for and compliance from the personnel. In other instances, data generated by the server computing devices 410 may be used to analyze the number of vehicles that go into and out of a depot for a given period of time. This may be used to estimate how congested one particular depot is as compared to others, allowing for better load balancing of depots and potentially other locations for the autonomous vehicles to part and wait.

The features described herein may provide for a more efficient and practical approach to managing a fleet of autonomous vehicles. As noted above, a fleet management system may automatically determine what such vehicles should be doing at a given point in time without the need for human operators to manually predict the future states of the vehicles and the utilization of resources to manage the system, thereby significantly reducing inefficiencies. The features described herein may also allow for more quickly and efficiently reacting to changes, both expected and unexpected, in supply and demand conditions for the autonomous vehicles. This, in turn, may reduce unproductive driving (e.g., “wasted miles” or “dead-heading”) thereby increasing efficiency, reducing overall costs, and potentially increasing revenue to the transportation system.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only some of many possible embodiments. Further, the same reference numbers in different drawings can identify the same or similar elements.

1. A method for managing a fleet of autonomous vehicles of a transportation service, the method comprising:
identifying, by one or more processors, a plurality of inputs including a current demand for services, predictions about future demand for services, and a current status of the fleet of autonomous vehicles including information identifying one of a plurality of predefined states for each autonomous vehicle of the fleet of autonomous vehicles;
determining, by the one or more processors, a schedule based on the plurality of inputs, wherein the schedule defines a number of autonomous vehicles of the fleet of autonomous vehicles that are predicted to be in each of a plurality of expected future states;
using, by the one or more processors, the schedule to determine an assignment assigning each of the autonomous vehicles of the fleet of autonomous vehicles to one of the plurality of predefined states; and
sending, by the one or more processors, to one of the autonomous vehicles of the fleet of autonomous vehicles an instruction to update the current status of the one of the autonomous vehicles based on the assignments, the instruction configured to cause the one of the autonomous vehicles of the fleet of autonomous vehicles to automatically change a behavior of the one of the autonomous vehicles of the fleet of autonomous vehicles.

2. The method of claim 1, further comprising, optimizing the schedule for a variable of interest.

3. The method of claim 2, wherein the variable of interest includes a number of trips.

4. The method of claim 1, wherein the plurality of inputs further includes a number of depot areas for the transportation service, locations for the depot areas, and statuses of the depot areas.

5. The method of claim 1, wherein the current demand for services includes a number of users who currently have an application for the transportation service open and have identified a destination.

6. The method of claim 1, further comprising, determining the future demand for services based on historical demand for transportation service.

7. The method of claim 1, wherein determining the schedule includes determining expected future states for a plurality of timesteps.

8. The method of claim 7, further comprising, evaluating performance of the transportation system by comparing the expected future states for the plurality of timesteps to actual states of the autonomous vehicles of the fleet of autonomous vehicles at corresponding times.

9. The method of claim 7, wherein the schedule further defines a number of autonomous vehicles of the fleet of autonomous vehicles that should be in each of the plurality of expected future states for each of the plurality of timesteps.

10. The method of claim 1, wherein determining the schedule includes determining when an autonomous vehicle of the fleet of autonomous vehicles will require maintenance.

11. The method of claim 1, wherein determining the schedule includes determining an amount of time that each autonomous vehicle of the fleet of autonomous vehicles will remain in a current state for that autonomous vehicle of the fleet of autonomous vehicles.

12. The method of claim 1, wherein using the schedule to determine the assignment includes using a plurality of downstream models arranged in a hierarchy.

13. The method of claim 12, further comprising, using output of the plurality of downstream models to identify an updated plurality of inputs in order to perform a second iteration of determining a schedule.

14. A system for managing a fleet of autonomous vehicles of a transportation service, the system comprising one or more processors configured to:
identify a plurality of inputs including a current demand for services, predictions about future demand for services, and a current status of the fleet of autonomous vehicles including information identifying one of a plurality of predefined states for each autonomous vehicle of the fleet of autonomous vehicles;
determine a schedule based on the plurality of inputs, based on the current state, wherein the schedule defines a number of autonomous vehicles of the fleet of autonomous vehicles that are expected to be in each of a plurality of expected future states;
use the schedule to determine an assignment assigning each of the autonomous vehicles of the fleet of autonomous vehicles to one of the plurality of predefined states; and
send to one of the autonomous vehicles of the fleet of autonomous vehicles an instruction to update the current status of the one of the autonomous vehicles of the fleet of autonomous vehicles based on the assignments, the instruction configured to cause the one of the autonomous vehicles of the fleet of autonomous vehicles to automatically change a behavior of the one of the autonomous vehicles of the fleet of autonomous vehicles.

15. The system of claim 14, wherein the one or more processors are further configured to optimize the schedule for a variable of interest.

16. The system of claim 14, wherein the one or more processors are further configured to determine the schedule by determining expected future states for a plurality of timesteps.

17. The system of claim 16, wherein the one or more processors are further configured to evaluate performance of the transportation system by comparing the expected future states for the plurality of timesteps to actual states of the autonomous vehicles of the fleet of autonomous vehicles at corresponding times.

18. The system of claim 16, wherein the schedule further defines a number of autonomous vehicles that should be in each of the plurality of expected future states for each of the plurality of timesteps.

19. The system of claim 14, wherein determining the schedule includes determining an amount of time that each autonomous vehicle of the fleet of autonomous vehicles will remain in a current state of that autonomous vehicle of the fleet of autonomous vehicles.

20. The system of claim 14, further comprising the fleet of autonomous vehicles.
